(19) United States
(12) Patent Application Publication
(10) Pub. No.: US 2026/0327810 A1
(43) Pub. Date: Oct. 22, 2026

(54) ELECTROLYSER, AND METHOD FOR OPERATING AN ELECTROLYSER

(71) Applicant: Siemens Energy Global GmbH & Co. KG, München (DE)

(72) Inventors: Erik Wolf, Röttenbach (DE); Christian Reller, Minden (DE)

(21) Appl. No.: 19/110,471

(22) PCT Filed: Sep. 4, 2023
(86) PCT No.: PCT/EP2023/074104

§ 371 Date: Mar. 11, 2025

(30) Foreign Application Priority Data
Sep. 26, 2022 (DE) 10 2022 210 095.6

(51) Int. Cl. C25B 1/04; C25B 9/05; C25B 9/70; C25B 15/027

(52) U.S. Cl. CPC C25B 1/04; C25B 9/05; C25B 9/70; C25B 15/027

(57) ABSTRACT

The invention pertains to an electrolyzer designed for water splitting into hydrogen and oxygen using electric current. It consists of multiple electrolysis cells grouped into stacks, each featuring a proton-permeable polymer membrane with electrodes on both sides. Water is supplied to the anode chamber, and generated oxygen is discharged from it, while hydrogen is discharged from the cathode chamber. A control system manages the operation of the electrolysis stacks, ensuring safe operation by maintaining a higher pressure in the anode chamber compared to the cathode chamber. The anode chamber pressure is set to be 2 to 20 times, preferably 4 to 7 times, higher than the cathode chamber pressure. This design minimizes the negative effects of membrane damage during operation. The system also allows for water circulation in both chambers and includes a recombination catalyst in the hydrogen product line to recombine hydrogen and oxygen into water.

### BACKGROUND

The invention relates to an electrolyzer for splitting water into hydrogen and oxygen by means of an electric current, comprising a plurality of electrolysis cells forming several electrolysis stacks, each electrolysis cell having a proton-permeable polymer membrane, on both sides of which are electrodes to which an external voltage is applied during operation, a water supply line for supplying water to an anode chamber being provided on the anode side, an oxygen product line for discharging the generated oxygen from the anode chamber being connected, and a hydrogen product line for discharging the generated hydrogen from the cathode chamber being provided on the cathode side, furthermore comprising a control system for controlling the operation of the electrolysis stacks.

The invention furthermore relates to a method for operating an electrolyzer for splitting water into hydrogen and oxygen by means of an electric current, comprising a plurality of electrolysis cells forming several electrolysis stacks, each electrolysis cell having a proton-permeable polymer membrane, on both sides of which are electrodes to which an external voltage is applied during operation, water being added to an anode chamber on the anode side and the generated oxygen being discharged from the anode chamber, and the generated hydrogen being discharged from a cathode chamber on the cathode side through a hydrogen product line.

Nowadays, hydrogen is generated, for example, by means of PEM electrolysis. A component of a PEM electrolysis cell is a proton-permeable polymer membrane (proton exchange membrane) which is contacted on both sides by porous platinum electrodes (anode and cathode). An external voltage is applied thereto, and water is supplied to the anode side of the electrolyzer. Due to the catalytic effect of the platinum, the water is decomposed on the anode side. This results in oxygen, free electrons and positively charged hydrogen ions H+. The hydrogen ions H+ diffuse through the proton-conducting membrane to the cathode side, where they combine with the electrons from the external electric circuit to form hydrogen molecules H₂.

The electrolysis cells described above are consolidated in stacks. Water is introduced into the stack carrying direct voltage and, after passing through the electrolysis cells, two product streams exit, consisting of water and gas bubbles as oxygen and hydrogen, respectively. In this regard, it is inherent to the system that within the product stream of the one product gas, respectively other product gas is present only in small amounts. In practice, small amounts of hydrogen are present in the oxygen gas stream and small amounts of oxygen are present in the hydrogen gas stream. The quantity of the respective foreign gas depends on the electrolysis cell design and varies under the influence of current density, catalyst composition, ageing and, in the case of a PEM electrolysis plant, of the membrane material. In some circumstances, it may be required in this regard to reduce the foreign gas concentration, namely already directly at or directly downstream of the electrolysis cell or the electrolysis stack, e.g., in a gas separation device connected downstream of the electrolyzer. The problem is exacerbated in part-load operation and in case of aged membranes and leads to restrictions in the mode of operation.

Gas separation is therefore necessary in the following. In this context, it is common for several electrolysis cells and, furthermore, several electrolysis units to be connected to one another via piping and for the gas-water mixture exiting in each case to be supplied to a central gas separator. An embodiment which is advantageous for this purpose is known, for example, from WO 2020/020611 A1.

### SUMMARY

Therefore, it is an object of the invention to ensure safe operation of the electrolyzer and to minimize the negative consequences of membrane damage during operation of an electrolyzer.

According to the invention, the object is attained by an electrolyzer for splitting water into hydrogen and oxygen by means of an electric current, comprising a plurality of electrolysis cells which are divided into electrolysis stacks, each electrolysis cell having a proton-permeable polymer membrane, on both sides of which are electrodes to which an external voltage is applied during operation, a first water supply line for supplying water to an anode chamber being provided on the anode side, an oxygen product line for discharging the generated oxygen from the anode chamber being connected, and a hydrogen product line for discharging the generated hydrogen from a cathode chamber being provided on the cathode side, furthermore comprising a control system for controlling the operation of the electrolysis stacks, wherein the control system is designed to set a higher pressure in the anode chamber than in the cathode chamber, the pressure in the anode chamber being 2 times to 20 times higher, in particular 4 times to 7 times higher, than the pressure in the cathode chamber.

According to the invention, the object is furthermore attained by a method for operating an electrolyzer for splitting water into hydrogen and oxygen by means of an electric current, comprising a plurality of electrolysis cells which are divided into electrolysis stacks, each electrolysis cell having a proton-permeable polymer membrane, on both sides of which are electrodes to which an external voltage is applied during operation, water being added to an anode chamber on the anode side via first a water supply line and the generated oxygen being discharged from the anode chamber via an oxygen product line, and the generated hydrogen being discharged from a cathode chamber on the cathode side via a hydrogen product line, furthermore comprising a control system for controlling the operation of the electrolysis stacks, wherein, by means of the control system, a higher pressure is set in the anode chamber than in the cathode chamber, the pressure in the anode chamber being 2 times to 20 times higher, in particular 4 times to 7 times higher, than the pressure in the cathode chamber.

The advantages and preferred forms mentioned below with respect to the electrolyzer may be transferred analogously to the method for operating an electrolyzer.

According to the invention, each electrolysis is proposed to be operated with a differential pressure. In this regard, the pressure on the anode side is set to be higher than on the cathode side. The pressure ratio between the anode side and the cathode side is 2 to 20 bar, in particular 4 to 7 bar. This means that if, e.g., a pressure of 5 bar is present in the cathode chamber, then in particular 20 bar is set in the anode chamber.

A lower pressure on the cathode side compared to the anode side involves several advantages. On the one hand, it supports the migration of the water molecules through the membrane. On the other hand, if the membrane breaks through, less foreign gas gets through. And not least, there is an improvement in the foreign gas concentration during operation.

According to one embodiment, the control system is designed to enable circulation of the water in the anode chamber. In one embodiment, the oxygen discharge line also serves as a water discharge line. If the water circulates only on the anode side, a humidified cell is present on the hydrogen side. The operation of a PEM electrolyzer with only one water cycle is less complex than it is with two cycles.

According to one embodiment, the control system is designed to enable circulation of the water in the cathode chamber. In this context, the hydrogen product line in particular also serves to discharge water. The water circulation improves the inherent safety of the electrolysis cell. In this regard, the circulation rate in the cathode chamber is in particular lower than that in the anode chamber. The ratio of the water circulation on the hydrogen side to the oxygen side is 0.9 to 0.01. In the event of membrane breakage, the oxygen passing through would normally be able to mix with the hydrogen and form a reactive gas mixture. It is therefore of great advantage in this regard for discrete, smaller volumes to form from the hydrogen-oxygen mixture, which are embedded in water, e.g., as bubbles. Due to the lower total reaction volume, the energy release is also lower.

In one embodiment, there is a horizontal cell structure in which the anode chamber is arranged above the cathode chamber. Alternatively, the cell may also be orientated vertically.

With regard to a particularly high level of safety in the electrolysis process, according to an embodiment, a recombination catalyst for recombining the hydrogen and the oxygen to form water is integrated in the hydrogen product line. With the aid of the recombination catalyst, a reactive product gas mixture is prevented from reaching a downstream gas separator or downstream regions such as, e.g., compressors due to the oxygen content in the hydrogen product stream.

In one embodiment, the control system is designed to detect at least one temperature value in the hydrogen product line and to compare the temperature value or a temperature correlated with the temperature value with a threshold value and, upon exceeding the threshold value, to block the hydrogen product line and to open a bypass line. The temperature value detected may be, for example, an absolute temperature in or downstream of the recombination catalyst, a temperature change over time, an inlet and outlet temperature relative to the recombination catalyst or a difference between two temperature values from the hydrogen product line. An exothermic reaction with an increase in temperature takes place in the recombination catalyst. As a result, if the temperature in the recombination catalyst or another temperature in the hydrogen product line rises above the specified threshold value, this is an indicator that a particularly large amount of foreign oxygen is present in the hydrogen product stream. This in turn suggests a membrane defect. Thus, it is essential, upon exceeding the threshold value, to block the hydrogen product line in order to prevent access to the gas separator, and to open the bypass line which passes the reactive mixture of oxygen and hydrogen out of the further components of the electrolysis plant.

In one embodiment, the control system is designed to deactivate the electric current to the electrolysis stack upon exceeding the threshold value. In this way, an increase in the concentration of foreign oxygen on the hydrogen side is prevented in a timely manner.

According to a further safety measure, the control system is advantageously designed to pass an inert gas into the cathode chambers of the deactivated electrolysis stack. In particular, nitrogen is used, with which the electrolysis stack is flushed on the cathode side.

### BRIEF DESCRIPTION OF THE FIGURES

An exemplary embodiment of the invention is explained in detail with reference to a drawing. In the figures, in a schematic and highly simplified manner:

FIG. 1 shows a first exemplary embodiment of an electrolysis cell in a vertical orientation,

FIG. 2 shows a second exemplary embodiment of an electrolysis cell in a horizontal orientation,

FIG. 3 shows a third exemplary embodiment of an electrolysis cell in a horizontal orientation,

FIG. 4 shows a fourth exemplary embodiment of an electrolysis cell in a horizontal orientation,

FIG. 5 shows a fifth exemplary embodiment of an electrolysis cell in a horizontal orientation, and

FIG. 6 shows a vertically orientated electrolysis cell with downstream components.

In the figures, like reference numerals have like meaning.

### DETAILED DESCRIPTION

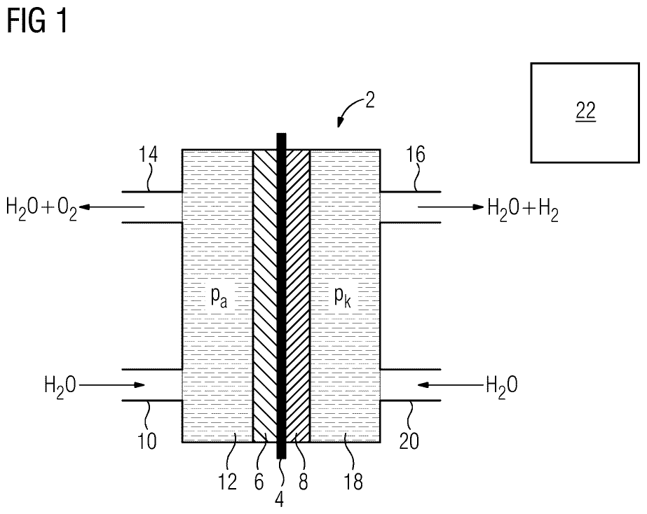

FIG. 1 depicts a vertically orientated electrolysis cell 2 which is part of an electrolyzer, not shown here, for splitting water into hydrogen H₂ and oxygen O₂ by means of an electric current. Several of such electrolysis cells 2 are connected in series in electrolysis stacks. Each electrolysis cell 2 has a proton-permeable polymer membrane 4, on both sides of which are electrodes 6, 8 to which an external voltage is applied during operation. The first water supply line 10 for supplying water to an anode chamber 12 is provided on the anode side. The oxygen O₂ generated in the electrolysis cell 2 is discharged from the anode chamber 12 via an oxygen product line 14. A hydrogen product line 16 for discharging the generated hydrogen from a cathode chamber 18 is provided on the cathode side. According to FIG. 1, a second water supply line 20 is also connected on the cathode side. Thus, water circulates not only through the anode chamber 12 but also through the cathode chamber 18.

Furthermore, a control system 22 for controlling the operation of the electrolysis stacks is provided, symbolically implied by block 22. With the aid of the control system 22, a higher pressure pa is set in the anode chamber 12 than the pressure pk in the cathode chamber 18, the pressure pa on the anode side being 2 times to 20 times higher. In one embodiment, the pressure pa in the anode chamber 12 is in particular 4 times to 7 times higher than the pressure pk in the cathode chamber 18. In this way, the negative consequences of membrane damage during operation of an electrolyzer are minimized since less foreign gas gets through in the event of a breakthrough of the membrane 4.

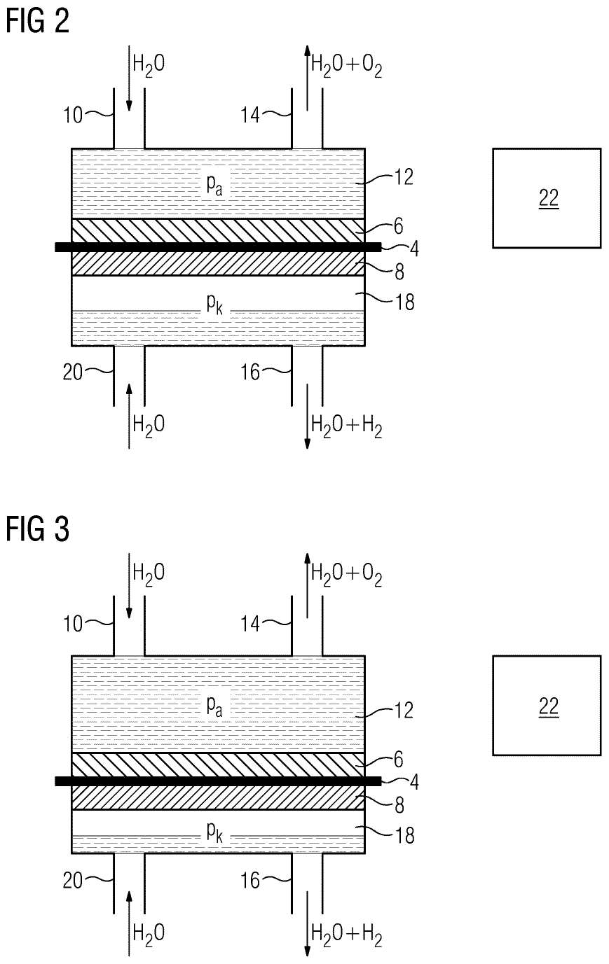

The electrolysis cell 2 in FIG. 2 has a horizontal structure in which the anode chamber 12 is arranged above the cathode chamber 18. In this regard, the cathode chamber 18 is only partially flooded, i.e., although water is passed into the cathode chamber 18 via the second water supply line 20, the chamber is not completely filled with water.

The horizontal electrolysis cell 2 according to FIG. 3 differs from the electrolysis cell 2 in FIG. 2 only in that the anode chamber 12 and the cathode chamber 18 are not the same size, but the anode chamber 12 is formed to be larger than the cathode chamber 18, i.e., there is an asymmetrical arrangement of the polymer membrane 4 with the electrodes 6, 8.

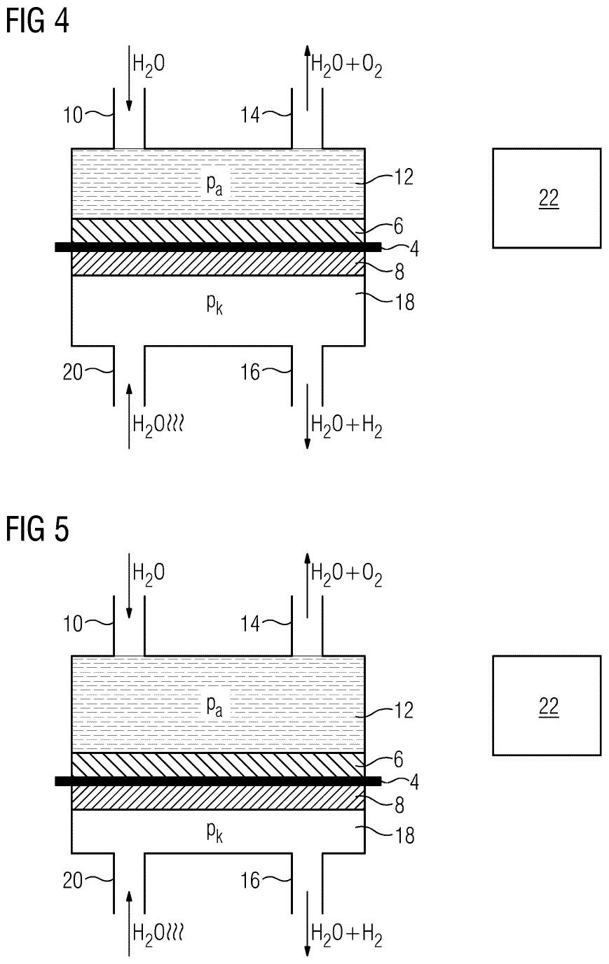

In contrast to FIG. 2, no liquid water is supplied into the cathode chamber 18 in FIG. 4, but water vapor, so that a humidified half-cell is present on the cathode side.

In the embodiment of the electrolysis cell 2 according to FIG. 5, a humidified half-cell is also present on the cathode side, and in this regard, here, as in FIG. 3, the anode chamber 12 is also formed to be larger than the cathode chamber 18.

The embodiments shown in connection with the horizontally orientated electrolysis cells 2 according to FIGS. 2, 3, 4 and 5 may also be transferred to vertically orientated electrolysis cells 2, and vice versa.

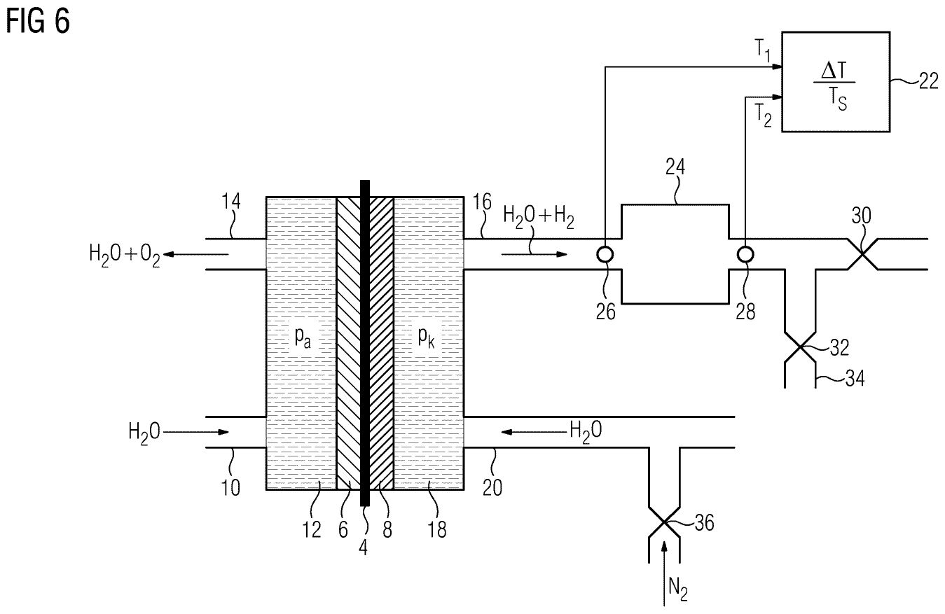

FIG. 6 shows further components of the electrolyzer and their cooperation during operation. A recombination catalyst 24 for recombining is integrated in the hydrogen product line 16, in which the hydrogen H₂ and the oxygen O₂ are recombined to form water. In the shown exemplary embodiment, upstream and downstream of the recombination catalyst 24, temperature sensors 26, 28 are attached, each of which detects a temperature value T₁, T₂in the hydrogen product line 16. The temperature values T₁, T₂ are made available to the control system 22, and a temperature difference value ΔT is formed therefrom by the control system 22 and this is compared with a specified threshold value Tₛ. Instead of the temperature difference value ΔT, a measured temperature value such as, e.g., T₂ or another temperature correlated with the temperature value T₂ may be used directly. In this way, temperature development of the exothermic reaction in the recombination catalyst 24 is monitored.

If the temperature difference value AT exceeds the threshold value T_{S}, the hydrogen product line 16 is blocked by the valve 30 and a bypass valve 32 is opened, so that the mixture of hydrogen H₂ and oxygen O₂ is passed out via a bypass line 34. Also, upon exceeding the threshold value T_{S}, the electric current to the respective electrolysis stack is deactivated for safety reasons. In addition, a nitrogen valve 36 built into the second water supply line 20 is opened, so that nitrogen N₂ or another inert gas is passed into the cathode chambers 18 of the deactivated electrolysis stack.

1. An electrolyzer for splitting water into hydrogen (H₂) and oxygen (O₂) by means of an electric current, comprising:
a plurality of electrolysis cells which are divided into electrolysis stacks, each electrolysis cell having a proton-permeable polymer membrane, on both sides of which are electrodes to which an external voltage is applied during operation, a first water supply line for supplying water to an anode chamber being provided on an anode side, an oxygen product line for discharging generated oxygen (O₂) from the anode chamber being connected, and a hydrogen product line for discharging generated hydrogen (H₂) from a cathode chamber being provided on a cathode side, furthermore comprising a control system for controlling the operation of the electrolysis stacks,
wherein the control system is designed to set a higher pressure (pₐ) in the anode chamber than in the cathode chamber, the pressure (pₐ) in the anode chamber being 2 times to 20 times higher, in particular 4 times to 7 times higher, than the pressure (pₖ) in the cathode chamber.

2. The electrolyzer according to claim 1,
wherein the control system is designed to enable circulation of the water in the anode chamber.

3. The electrolyzer according to claim 1,
wherein the control system is designed to enable circulation of the water in the cathode chamber.

4. The electrolyzer according to claim 1,
wherein a horizontal cell structure is present in which the anode chamber is arranged above the cathode chamber.

5. The electrolyzer according to claim 1,
wherein a recombination catalyst for recombining the hydrogen (H₂) and the oxygen (O₂) to form water is integrated in the hydrogen product line.

6. The electrolyzer according to claim 1,
wherein the control system is designed to detect at least one temperature value (T₁, T₂) in the hydrogen product line and to compare the temperature value (T1, T2) or a temperature (ΔT) correlated with the temperature value (T₁, T₂) with a threshold value (Tₛ) and, upon exceeding the threshold value (Tₛ), to block the hydrogen product line and to open a bypass line.

7. The electrolyzer according to claim 6,
wherein the control system is designed to, upon exceeding the threshold value (Tₛ), deactivate the electric current to the respective electrolysis stack.

8. The electrolyzer according to claim 6,
wherein the control system is designed to pass an inert gas (N₂) into the cathode chambers of the deactivated electrolysis stack.

9. A method for operating an electrolyzer for splitting water into hydrogen (H₂) and oxygen (O₂) by means of an electric current, comprising a plurality of electrolysis cells which are divided into electrolysis stacks, each electrolysis cell having a proton-permeable polymer membrane, on both sides of which are electrodes to which an external voltage is applied during operation, water being added to an anode chamber on the anode side via first a water supply line and the generated oxygen (O₂) being discharged from the anode chamber via an oxygen product line, and the generated hydrogen (H₂) being discharged from a cathode chamber on the cathode side via a hydrogen product line, furthermore comprising a control system for controlling the operation of the electrolysis stacks,
wherein, by means of the control system, a higher pressure (pₐ) is set in the anode chamber than in the cathode chamber, the pressure (pₐ) in the anode chamber being 2 times to 20 times higher, in particular 4 times to 7 times higher, than the pressure (pₖ) in the cathode chamber.

10. The method for operating an electrolyzer according to claim 9,
wherein water circulates through the anode chamber.

11. The method for operating an electrolyzer according to claim 9,
wherein water circulates through the cathode chamber.

12. The method for operating an electrolyzer according to claim 9,
wherein a recombination catalyst is integrated in the hydrogen product line, in which the hydrogen (H₂) and the oxygen (O₂) are recombined to form water.

13. The method for operating an electrolyzer according to claim 12,
wherein at least one temperature value (T₁, T₂) is detected in the hydrogen product line and the temperature value (T₁, T₂) or a temperature (ΔT) correlated with the temperature value is compared with a threshold value (Ts) and, upon exceeding the threshold value (Ts), the hydrogen product line is blocked and a bypass line is opened.

14. The method for operating an electrolyzer according to claim 13,
characterized in that, upon exceeding the threshold value (Ts), the electric current to the respective electrolysis stack is deactivated.

15. The method for operating an electrolyzer according to claim 14,
wherein an inert gas (N₂) is passed into the cathode chambers of the deactivated electrolysis stack.
